(19) United States
(12) Patent Application Publication
(10) Pub. No.: US 2008/0228322 A1
(43) Pub. Date: Sep. 18, 2008

(54) Actuator drive system having smart sensor module and smart actuator module

(75) Inventors: Jin-Hwan Lee, Bundang-gu (KR); Hyung-Tae Moon, Seoul (KR)

Correspondence Address: HARNESS, DICKEY & PIERCE, P.L.C., P.O. BOX 828, BLOOMFIELD HILLS, MI, 48303, US

(73) Assignee: Mando Corporation

(21) Appl. No.: 12/075,430

(22) Filed: Mar. 11, 2008

(30) Foreign Application Priority Data
Mar. 14, 2007 (KR) 10-2007-0024896

(51) Int. Cl. G05B 15/02

(52) U.S. Cl. 700/275

(57) ABSTRACT

Disclosed is an actuator drive system including a smart sensor module including a sensor, a sensor input unit, and a controller; a smart actuator module including a drive output unit and an actuator; and a battery for supplying each of the smart sensor module and the smart actuator module with power. Advantageously, the conventional ECU is replaced with the smart sensor module and the smart actuator module, and the smart sensor module and the smart actuator module are connected to each other by a cable. Therefore, noise or heat generated by the smart actuator module is not transferred to the smart sensor module. When one of the smart sensor module and the smart actuator module malfunctions, only the malfunctioning module is replaced. In addition, when the specification of the sensor (or actuator) is modified, the design of the smart sensor module (or smart actuator module) alone is modified.

### CROSS-REFERENCE TO RELATED APPLICATION

This non-provisional application claims priority under 35 U.S.C §119(a) on Patent Application No. 10-2007-0024896 filed in Korea on Mar. 14, 2007, the entire contents of which are hereby incorporated by reference.

### BACKGROUND OF THE INVENTION

1. Field of the invention

The present invention relates to an actuator drive system having a smart sensor module and a smart actuator module. More particularly, the present invention relates to an actuator drive system having a smart actuator module, which includes a drive output unit and an actuator, and a smart sensor module, which includes a sensor, a sensor input unit, and a controller, the smart actuator module and the smart sensor module being connected to each other by a connection cable.

2. Description of the Prior Art

As generally known in the art, vehicles are equipped with an actuator drive system, which includes an ECU (Electronic Control Unit) for receiving electric signals detected by various vehicular sensors and outputting digital control signals for driving various output-side actuators.

The ECU drives actuators (e.g. motors, solenoids) based on signals received from various sensors mounted inside the vehicle and controls the automatic transmission, the drive system, the brake system, the steering system, etc.

FIG. 1 briefly shows an actuator drive system including an ECU.

Referring to FIG. 1, the actuator drive system includes an ECU 100, a vehicular sensor 140, and an actuator 150. The ECU 100 includes a sensor input unit 110, an MCU (Micro Controller Unit) 120, and a drive output unit 130. The sensor input unit 110 includes a sensor interface 112, a sensor/MCU power supply 114, and a sensor connector 116. The drive output unit 130 includes a main power device 132, a drive circuit 134, a heat radiation plate 136, and an actuator connector 138.

The sensor input unit 110 connects to the sensor 140, which is mounted inside the vehicle, via the sensor connector 116. The sensor input unit 110 includes a sensor interface 112, which is a circuit for converting various types of signals received from the sensor 140 into values that the MCU 120 can process, and a sensor/MCU power supply 114 for converting the power supplied from the battery 116 into sensor power and MCU power, which correspond to rated power for the sensor 140 and that for the MCU 120, respectively, and supplying the sensor 140 and the MCU 120 with the corresponding power. As such, the sensor input unit 110 provides the sensor 140 with sensor power, receives signals from the sensor 140, and transmits the signals to the MCU 120.

The MCU 120 receives signals, which have been converted by the sensor interface 112, from the sensor input unit 110 and combines them with control variable signals, which are fed back from the actuator 150. The MCU 120 operates the combined signals and outputs low-power control signals for controlling the actuator 150.

The MCU 120 is powered by the sensor/MCU power supply 114.

The drive output unit 130 includes a main power device 132, which includes a relay, a capacitor, and a power switching device, a drive circuit 134, and a heat radiation plate 136.

The drive output unit 130 amplifies lower-power control signals received from the MCU 120, and drives the actuator 150 by means of the drive circuit 134. The drive output unit 130 subjects the power, which has been supplied from the battery 160, to DC-DC or DC-AC conversion by using the main power device 132, and supplies the actuator 150 with the converted power (i.e. actuator power), which is high-level power.

The drive output unit 130 has a heat radiation plate 136 attached to the main power device 132, as well as to other heat-generating devices, in order to radiate heat from them. The drive output unit 130 connects to the actuator 150 via the actuator connector 138.

The ECU 100, which is constructed as mentioned above, has the following problems: the fact that the sensor input unit 110, the MCU 120, and the drive output unit 130 constitute an integral unit increases the possibility that the sensor input unit 110 or the MCU 120 will malfunction due to noise or heat generated by the drive output unit 130, which handles high power. In addition, the entire ECU 100 (i.e. the sensor input unit 110, the MCU 120, and the drive output unit 130 as a whole) must be replaced even when only one of the sensor input unit 110, the MCU 120, and the drive output unit 130 malfunctions. This increases the cost for producing or repairing the vehicle.

Furthermore, any change in the specification of the sensor 140, which includes a steering torque sensor, a vehicle speed sensor, a cooling water temperature sensor, a wheel speed sensor, etc., or of the actuator 150, which includes a solenoid, a motor, etc., must be followed by overall modification of the ECU 100. This increases the material cost and makes the design difficult.

### SUMMARY OF THE INVENTION

Accordingly, the present invention has been made to solve the above-mentioned problems occurring in the prior art, and the present invention provides an actuator drive system having a smart actuator module, which includes a drive output unit and an actuator, and a smart sensor module, which includes a sensor, a sensor input unit, and a controller, the smart actuator module and the smart sensor module being connected to each other by a connection cable.

In accordance with an aspect of the present invention, there is provided an actuator drive system for driving an actuator by receiving a sensor signal detected by a sensor, the actuator drive system including a smart sensor module including a sensor, a sensor input unit, and a controller; a smart actuator module including a drive output unit and an actuator; and a battery for supplying each of the smart sensor module and the smart actuator module with power.

### BRIEF DESCRIPTION OF THE DRAWINGS

The above and other objects, features, and advantages of the present invention will be more apparent from the following detailed description taken in conjunction with the accompanying drawings, in which:

FIG. 1 briefly shows an actuator drive system including a vehicular ECU according to the prior art; and

FIG. 2 briefly shows an actuator drive system having a smart sensor module and a smart actuator module according to an exemplary embodiment of the present invention.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted. Furthermore, a detailed description of known functions and configurations incorporated herein is omitted to avoid making the subject matter of the present invention unclear.

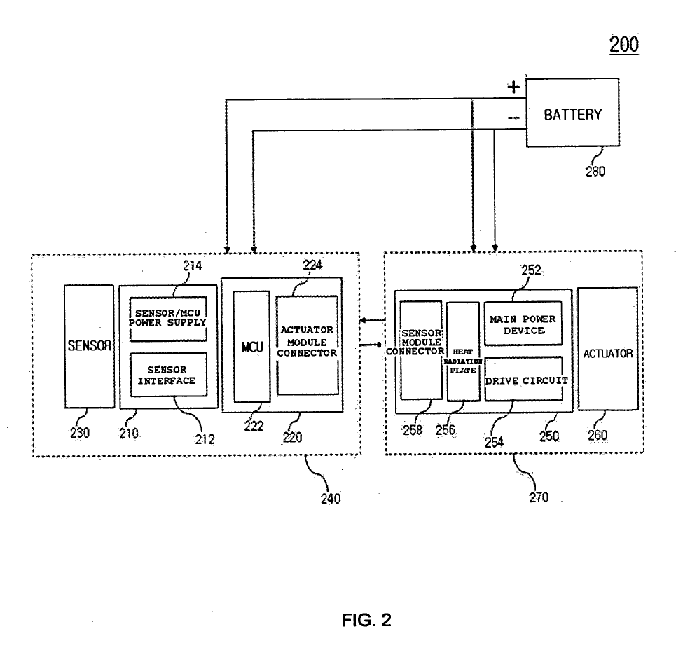

FIG. 2 briefly shows an actuator drive system having a smart sensor module and a smart actuator module according to an exemplary embodiment of the present invention.

The actuator drive system 200 according to an exemplary embodiment of the present invention includes a smart sensor module 240, a smart actuator module 270, and a battery 280.

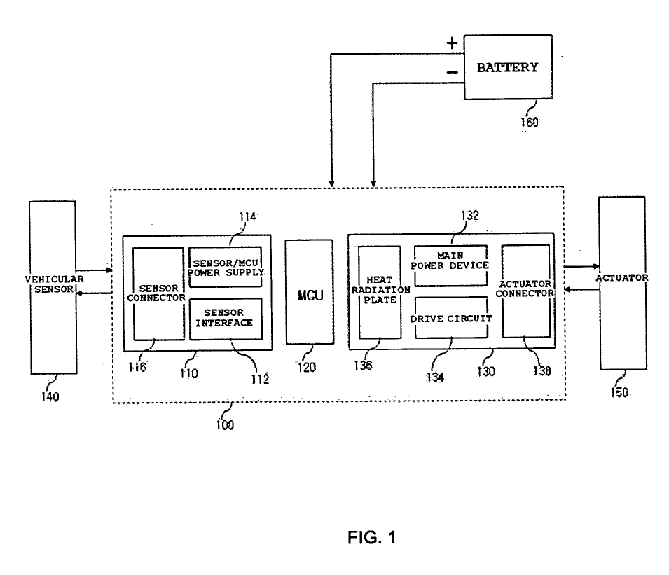

Detailed descriptions of the same components of the actuator drive system 200 according to an exemplary embodiment of the present invention, including the smart sensor module 240, the smart actuator module 270, and their sub-components, as those described with reference to FIG. 1 will be omitted herein.

In addition, although it will be assumed for convenience of description that connectors are used to connect between the smart sensor module 240 and the smart actuator module 270, other types of connecting devices can also be employed.

The smart sensor module 240 includes a sensor input unit 210, a controller 220, and a sensor 230. The sensor input unit 210 includes a sensor interface 212 and a sensor/MCU power supply 214. The controller 220 includes an MCU 222 for outputting control signals and an actuator module connector 224.

The sensor interface 212 of the smart sensor module 240 according to an exemplary embodiment of the present invention supplies a vehicular sensor 260 with sensor power via a circuit connected to the sensor 230, or receives sensor signals from the sensor 230.

The smart sensor module 240 has an actuator module connector 224 to connect to the smart actuator module 270. Particularly, the smart sensor module 240 connects to the sensor module connector 258 of the actuator module 270 via the actuator module connector 224 to transmit control signals to the smart actuator module 270 and to receive control variable signals from the smart actuator module 270. The actuator module connector 224 and the sensor module connector 258 are connected to each other by a connection cable, which has connectors on both ends to connect to the actuator module connector 224 and the sensor module connector 258, respectively.

The smart actuator module 270 includes a drive output unit 250 and an actuator 260. The drive output unit 250 includes a main power device 252, a drive circuit 254, a heat radiation plate 256, and a sensor module connector 258.

The smart actuator module 270 according to an exemplary embodiment of the present invention receives control signals from the smart sensor module 240 and transmits control variable signals, which are fed back from the actuator 260, to the smart sensor module 240 via the connection cable, which has connectors for connecting the actuator module connector 224 of the smart sensor module 240 to the sensor module connector 258 of the smart actuator module 270.

The drive circuit 254 of the smart actuator module 270 outputs drive signals and actuator power, and transmits them to the actuator 260 via a circuit connected to the actuator 260. The drive circuit 254 receives control variable signals, which are fed back by the actuator 260, from the actuator 260. As used herein, the actuator power refers to high-level power which has been supplied from the battery 280 and which has been subjected to DC-DC or DC-AC conversion by the main power device 252 of the smart actuator module 270 to be supplied to the actuator 260.

As such, the actuator drive system 200 according to an exemplary embodiment of the present invention replaces the conventional ECU 100 (shown in FIG. 1) with the smart sensor module 240, which includes the sensor input unit 210, the controller 220, and the sensor 230, and the smart actuator module 270, which includes the drive output unit 250 and the actuator 260. Consequently, if the specification of the sensor 230 is modified, the design of the smart sensor module 240 alone is modified without modifying the entire design of the ECU 100. In addition, if the smart sensor module 240 malfunctions, the smart sensor module 240 alone is replaced without replacing the entire ECU 100.

Similarly, if the specification of the actuator 260 is modified, the design of the smart actuator module 270 alone is modified without modifying the entire design of the ECU 100. In addition, if the smart actuator module 270 malfunctions, the smart actuator module 270 alone is replaced without replacing the entire ECU 100.

The smart sensor module 240 and the smart actuator module 270 according to an exemplary embodiment of the present invention have respective power lines connecting to the battery 280.

This guarantees that the battery 280 supplies each of the smart sensor module 240 and the smart actuator module 270 with power.

As mentioned above, the actuator drive system according to the present invention has the following advantages: the conventional ECU is replaced with the smart sensor module, which includes the sensor, the sensor input unit, and the controller, and the smart actuator module, which includes the drive output unit and the actuator, and the smart sensor module and the smart actuator module are connected to each other by a cable. Therefore, noise or heat generated by the smart actuator module is not transferred to the smart sensor module. When one of the smart sensor module and the smart actuator module malfunctions, only the malfunctioning module is replaced. In addition, when the specification of the sensor is modified, the design of the smart sensor module alone is modified. Similarly, when the specification of the actuator is modified, the design of the smart actuator module alone is modified.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An actuator drive system for driving an actuator by receiving a sensor signal detected by a sensor, the actuator drive system comprising:
a smart sensor module having a sensor, a sensor input unit, and a controller;
a smart actuator module having a drive output unit and an actuator; and
a battery for supplying each of the smart sensor module and the smart actuator module with power.

2. The actuator drive system as claimed in claim 1, wherein the sensor input unit comprises a sensor interface and a sensor/MCU power supply.

3. The actuator drive system as claimed in claim 1, wherein the controller comprises an MCU and an actuator module connector.

4. The actuator drive system as claimed in claim 1, wherein the drive output unit comprises a main power device, a drive circuit, a heat radiation plate, and a sensor module connector.

5. The actuator drive system as claimed in claim 1, wherein the smart sensor module and the smart actuator module are connected to each other by a connection cable having connectors on both ends for connecting to the actuator module connector and the sensor module connector, respectively.

6. The actuator drive system as claimed in claim 5, wherein the smart sensor module is adapted to transmit a control signal outputted by the MCU to the smart actuator module via the connection cable, and the smart actuator module is adapted to transmit a control variable signal fed back by the actuator to the smart sensor module via the connection cable.
